(19) United States
(12) Patent Application Publication
(10) Pub. No.: US 2010/0131306 A1
(43) Pub. Date: May 27, 2010

(54) SYSTEM AND METHOD FOR CALCULATING AND PROVIDING A PREDETERMINED PAYMENT OBLIGATION

(75) Inventors: Samson Koo, Scarsdale, NY (US); Yidong Ding, New York, NY (US); Shilpa Akella, Jersey City, NJ (US)

Correspondence Address: AMSTER, ROTHSTEIN & EBENSTEIN LLP, 90 PARK AVENUE, NEW YORK, NY, 10016, US

(73) Assignee: BARCLAYS BANK PLC, London (GB)

(21) Appl. No.: 12/620,255

(22) Filed: Nov. 17, 2009

Related U.S. Application Data
(63) Continuation-in-part of application No. 11/803,592, filed on May 14, 2007.

(51) Int. Cl. G06Q 40/00

(52) U.S. Cl. 705/4; 705/37

(57) ABSTRACT

A system and method is provided for calculating and generating a predetermined payment obligation. A hypothetical portfolio of securities is selected having an initial value. A financial instrument is issued that references the hypothetical portfolio, the financial instrument having a fixed term. A guaranteed minimum withdrawal benefit is deducted from a net asset value of the hypothetical portfolio on a periodic basis for the fixed term. The net asset value of the hypothetical portfolio is determined to be zero if the net asset value of the hypothetical portfolio falls below a predetermined amount of funds. An adjustment in the number of securities in the hypothetical portfolio is calculated with a computer on a periodic basis according to an algorithm, the algorithm taking into account at least one of a prevailing market value of the securities in the hypothetical portfolio and a net present value of an obligation to deduct the predetermined amount of funds until the end of the fixed term. At the end of the fixed term, the net asset value of the hypothetical portfolio is paid.

### RELATED APPLICATIONS

This application is a continuation-in part of U.S. patent application Ser. No. 11/803,592, entitled HEDGED FINANCIAL PRODUCT HAVING A GUARANTEED MINIMUM WITHDRAWAL BENEFIT AND METHOD OF GENERATING THE SAME, filed May 14, 2007, the contents of which are incorporated herein by reference.

### FIELD OF THE INVENTION

This application is directed to financial products.

### BACKGROUND OF THE INVENTION

A guaranteed minimum withdrawal benefit (GMWB) is a relatively recent innovation in the variable annuity market. The GMWB is an obligation that promises a minimum payout level from an initial investment capital regardless of the performance of the assets in the separate account under the policy. More precisely, even when the value of the assets in the separate account (initial investment capital net of withdrawal and proportional insurance fees) of the policyholder falls to zero (or below) prior to the policy maturity date, the insurer continues to provide the guaranteed withdrawal amount until the specified maturity. If the account stays positive at maturity, the whole remaining balance in the account is paid to the policyholder at maturity. Thus, the total sum of cash flows received by the policyholder is guaranteed to be the same or above the original premium deposit.

Issuers of insurance policies, like insurance companies, offering GMWB riders are more commonly hedging the risks associated with providing such riders. This shift in insurer practices has been motivated by several factors. First, the economic risk of GMWBs are too significant to leave unhedged. Second, changes to Generally Accepted Accounting Principles (GAAP) accounting and statutory capital rules provide significant financial management incentives. Finally, rating agencies and market analysts look less favorably on insurers with significant exposure to stock market fluctuations.

Accordingly, there is a need for an effective and relatively simple method to hedge the risk associated with predetermined payment obligations, such as those in GMWBs and other fixed or variable payment obligations, offered as part of a financial product.

### SUMMARY OF THE INVENTION

A method according to an exemplary embodiment of the present invention comprises the steps of: selecting a hypothetical portfolio of securities having an initial value; issuing a financial instrument that references the hypothetical portfolio, the financial instrument having a fixed term; deducting the guaranteed minimum withdrawal benefit from a net asset value of the hypothetical portfolio on a periodic basis for the fixed term; determining the net asset value of the hypothetical portfolio to be zero if the net asset value of the hypothetical portfolio falls below a predetermined amount of funds; calculating an adjustment in the number of securities in the hypothetical portfolio on a periodic basis according to an algorithm, the algorithm taking into account at least one of a prevailing market value of the securities in the hypothetical portfolio and a net present value of an obligation to deduct the predetermined amount of funds until the end of the fixed term; and paying at the end of the fixed term the net asset value of the hypothetical portfolio.

According to an exemplary embodiment of the present invention, a computer-based system comprises at least one computer readable media containing computer readable instructions executable on at least one computer processors to perform a method comprising the steps of: selecting a hypothetical portfolio of securities having an initial value; issuing a financial instrument that references the hypothetical portfolio, the financial instrument having a fixed term; deducting a guaranteed minimum withdrawal benefit from a net asset value of the hypothetical portfolio on a periodic basis for the fixed term; determining the net asset value of the hypothetical portfolio to be zero if the net asset value of the hypothetical portfolio falls below a predetermined amount of funds; calculating an adjustment in the number of securities in the hypothetical portfolio on a periodic basis according to an algorithm, the algorithm taking into account at least one of a prevailing market value of the securities in the hypothetical portfolio and a net present value of an obligation to deduct the predetermined amount of funds until the end of the fixed term; and paying at the end of the fixed term the net asset value of the hypothetical portfolio.

In at least one embodiment, the method further comprises the step of issuing a second financial instrument, the second financial instrument being an annuity that pays the guaranteed minimum withdrawal benefit on the periodic basis for the fixed term.

In at least one embodiment, the algorithm is based on the following formula:

$$net asset value ( NAV ) = ( market value ( MV ) ) ( Number ( N ) of Security ( 1 ) ) + MV ( 2 ) ( N ( 2 ) ) + … ( MV ( N ) ) ( N ( n ) ) , \\ where \\ ( MV ( 1 ) ) ( N ( 1 ) ) / NAV = Constant ( 1 ) \\ ( MV ( 2 ) ) ( N ( 2 ) ) / NAV = Constant ( 2 ) \\ ⋮ \\ ( MV ( n ) ) ( N ( n ) ) / NAV = Constant ( n ) , \\ and \\ N ( 1 ) = F 1 \{ NAV , MV ( 1 ) , PV ( outstanding withdrawal obligation ) \} \\ N ( 2 ) = F 2 \{ NAV , MV ( 2 ) , PV ( outstanding withdrawal obligation ) \} \\ ⋮ \\ N ( n ) = Fn \{ NAV , MV ( n ) , PV ( outstanding withdrawal obligation ) \}$$

In at least one embodiment, the hypothetical portfolio is based on at least one of the S&P 500 Index, the Dow Jones Industrial Average, the NASDAQ Composite Index, the NASDAQ-100 Index, the Russell 1000 Index, the Russell 2000 Index, the Russell 3000 Index, and the Wilshire 5000 Index, the Barclays Capital U.S. Aggregate Index, and exchange traded funds tracking any of these or similar indices.

A method according to an exemplary embodiment of the present invention comprises the steps of: selecting a hypothetical portfolio of securities having an initial value; issuing a financial instrument that references the hypothetical portfolio, the financial instrument having a fixed term; deducting a predetermined payment obligation from a net asset value of the hypothetical portfolio on a periodic basis for the fixed term; determining the net asset value of the hypothetical portfolio to be zero if the net asset value of the hypothetical portfolio falls below a predetermined amount of funds; calculating with a computer an adjustment in a number of securities in the hypothetical portfolio on a periodic basis according to an algorithm, the algorithm taking into account at least one of a prevailing market value of the securities in the hypothetical portfolio and a net present value of an obligation to deduct the predetermined amount of funds until the end of the fixed term; and paying at the end of the fixed term the net asset value of the hypothetical portfolio.

According to an exemplary embodiment of the present invention, a computer-based system comprising one or more computer readable media containing computer readable instructions executable on one or more computer processors to perform a method comprising the steps of: processing data concerning a hypothetical portfolio of securities having an initial value; processing data concerning a financial instrument that references the hypothetical portfolio, the financial instrument having a fixed term; deducting a predetermined payment obligation from a net asset value of the hypothetical portfolio on a periodic basis for the fixed term; determining the net asset value of the hypothetical portfolio to be zero if the net asset value of the hypothetical portfolio falls below a predetermined amount of funds; calculating an adjustment in a number of securities in the hypothetical portfolio on a periodic basis according to an algorithm, the algorithm taking into account at least one of a prevailing market value of the securities in the hypothetical portfolio and a net present value of an obligation to deduct the predetermined amount of funds until the end of the fixed term; and paying at the end of the fixed term the net asset value of the hypothetical portfolio.

In at least one embodiment, the predetermined payment obligation is one of a fixed or variable payment obligation.

In at least one embodiment, the predetermined payment obligation is a guaranteed minimum withdrawal benefit.

A method for generating a hedged financial product having a guaranteed minimum withdrawal benefit according to an exemplary embodiment of the present invention comprises the steps of: formulating a financial product having a guaranteed minimum withdrawal benefit which is defined by a payout calculated based on a function of an investment value of an underlying asset, the investment value being tied to a benchmark that changes based on a first algorithm; and hedging a risk associated with the guaranteed minimum withdrawal benefit by investing funds in one or more assets in accordance with a second algorithm which is a function of the first algorithm.

In at least one embodiment, the function of the investment value is a percentage of the investment value at a specified date.

In at least one embodiment, the specified date is a date of inception of the underlying asset.

In at least one embodiment, the specified date is an observation date of a high watermark of the investment value.

In at least one embodiment, the function of the investment value is an average of the investment value over a range of dates.

In at least one embodiment, the underlying asset comprises an account containing an insurance premium paid by an insurance policyholder.

In at least one embodiment, the insurance premium is received as a lump sum.

In at least one embodiment, the insurance premium is received as payments over time.

In at least one embodiment, the payout is triggered by the investment value reaching a high watermark.

In at least one embodiment, an output of the second algorithm is at least one of expected value of the payout and probability of paying the expected value.

In at least one embodiment, the one or more assets include one or more of the following: exchange traded financial products and over-the-counter financial products.

In at least one embodiment, the one or more assets include one or more of the following: stocks, exchange-traded funds (ETFs), fixed income securities, futures contracts on equities, future contracts on fixed income securities, forward contracts on equities, forward contracts on fixed income securities, option contracts on equities, and option contracts on fixed income securities.

In at least one embodiment, the second algorithm is selected from one of the following types of algorithms: Monte Carlo Simulation, Finite Difference Method, Binomial/Trinomial Tree Method, Black-Scholes Model, Barone Adesi and Whaley Approximation, Variance Gamma Process, Heath-Jarrow-Morton Framework, and Heston Model.

In at least one embodiment, the function which is a percentage is fixed.

In at least one embodiment, the payout comprises periodic payments.

In at least one embodiment, the payout is a lump sum payment.

In at least one embodiment, amount of the periodic payments depends on the specified date.

In at least one embodiment, number of periodic payments depends on the specified date.

In at least one embodiment, the financial product is an insurance product.

In at least one embodiment, the financial product is an exchange traded financial product or an over-the-counter financial product.

In at least one embodiment, the financial product is selected from one of the following types of financial products: stocks, funds, fixed income securities, futures contracts on equities, future contracts on fixed income securities, forward contracts on equities, forward contracts on fixed income securities, option contracts on equities, and option contracts on fixed income securities.

According to an exemplary embodiment of the present invention, at least one computer readable media has instructions executable on at least one computer processors for performing a method for generating a hedged financial product having a guaranteed minimum withdrawal benefit, where the method comprises the steps of: formulating a financial product having a guaranteed minimum withdrawal benefit which is defined by a payout calculated based on a function of an investment value of an underlying asset, the investment value being tied to a benchmark that changes based on a first algorithm; and hedging a risk associated with the guaranteed minimum withdrawal benefit by investing funds in one or more assets in accordance with a second algorithm which is a function of the first algorithm.

A computer-based system for generating a hedged financial product having a guaranteed minimum withdrawal benefit according to an exemplary embodiment of the present invention comprises: memory that stores data relating to the financial product; at least one computer-readable medium comprising: a financial product analyzer that generates a first set of instructions for tracking performance of an investment value that changes based on a first algorithm; a guaranteed minimum withdrawal benefit engine that generates a second set of instructions for determining the guaranteed minimum withdrawal benefit as defined by a payout calculated based on a function of the investment value as tracked by the financial product analyzer; a hedge investment analyzer that generates a third set of instructions for determining one or more assets in which to invest to hedge risk associated with the guaranteed minimum withdrawal benefit in accordance with a second algorithm which is a function of the first algorithm; and a hedging engine that generates a fourth set of instructions for investing funds in the one or more assets; and a processor that executes the first, second, third and fourth set of instructions.

These and other features of this invention are described in, or are apparent from, the following detailed description of various exemplary embodiments of this invention.

### BRIEF DESCRIPTION OF THE DRAWINGS

Various exemplary embodiments of this invention will be described in detail, with reference to the following figures, wherein:

FIG. 1 is a graph illustrating a guaranteed minimum withdrawal benefit (GMWB) rider on a financial product according to an exemplary embodiment of the present invention;

FIG. 2 is a graph illustrating a high watermark calculation procedure used with a financial product according to an exemplary embodiment of the present invention;

FIG. 3 is a block diagram of a system for generating an financial product having a GMWB according to an exemplary embodiment of the present invention; and

FIG. 4 is a flow chart of a method of using a financial instrument to guarantee a GMWB in accordance with an embodiment of present invention.

### DETAILED DESCRIPTION OF PREFERRED EMBODIMENTS

Various exemplary embodiments of the present invention are directed to a system and method for generating a hedged financial product having a predetermined payment obligation. The concepts described herein may be applied to hedged financial products having payment obligations, such as a guaranteed minimum withdrawal benefit (GMWB), as well as other obligations, such as, for example, fixed or variable obligations that a financial institution is obligated to pay out.

Although the present disclosure is directed primarily to an insurance product, it should be appreciated that the concepts described herein may also be applied to other types of financial products, such as, for example, exchange traded financial products and over-the-counter financial products, and more particularly to stocks, funds, fixed income securities, futures contracts on equities, future contracts on fixed income securities, forward contracts on equities, forward contracts on fixed income securities, option contracts on equities, option contracts on fixed income securities, and the like.

FIG. 1 shows a graph, generally designated by reference number 100, which illustrates the function of a GMWB rider on a financial product, such as an insurance product, according to an exemplary embodiment of the present invention. The hypothetical values depicted in the graph 100 are illustrative only and are not meant to limit the present invention to such values or range of values. The graph 100 shows the underlying investment value diminishing over time until it reaches a value of $0 at the end of the twelfth year. Thus, the “high watermark” of the investment value is the initial value of $100,000 at year 0. It should be appreciated that in other instances, the investment value may increase after the initial investment such that the high watermark is reached sometime after year 0. Additionally, there may be more than one high watermark in the case where the investment value increases and decreases over time.

The investment value may be based on the performance of the assets in a separate account under the policy. The separate account may be funded by, for example, an insurance premium paid by an insurance holder, in a lump sum or as variable or fixed payments over time. Investments may be made in any number and type of financial products, such as, for example, equities or equity-linked investments instruments, fixed income or fixed income linked investment instruments, foreign currency or foreign currency linked investment instruments, commodities or commodity linked instruments, inflation linked instruments, credit linked instruments, and any other kind of investments. Preferably, the investment value of the underlying asset is tied to a benchmark, such as, for example, an index value or basket (i.e., value of several indices). Thus, the investment value may be modeled based on an algorithm that defines the investment value.

The availability of guaranteed withdrawals may be triggered by one or more events, such as, for example, the investment value reaching a predetermined percentage of the high watermark. In the example shown in the graph 100, guaranteed withdrawals are made by the policyholder at year 6 since the investment value reached a predetermined percentage of the high watermark of $100,000. The value of the guaranteed withdrawals is preferably defined by a payout calculated based on a function of an investment value of an underlying asset. For example, the function may be a percentage of the high watermark of the investment value, where the percentage is fixed, or an average of the investment value over a range of dates. The individual payments on the payout are preferably periodic payments, for example, monthly or annual payments.

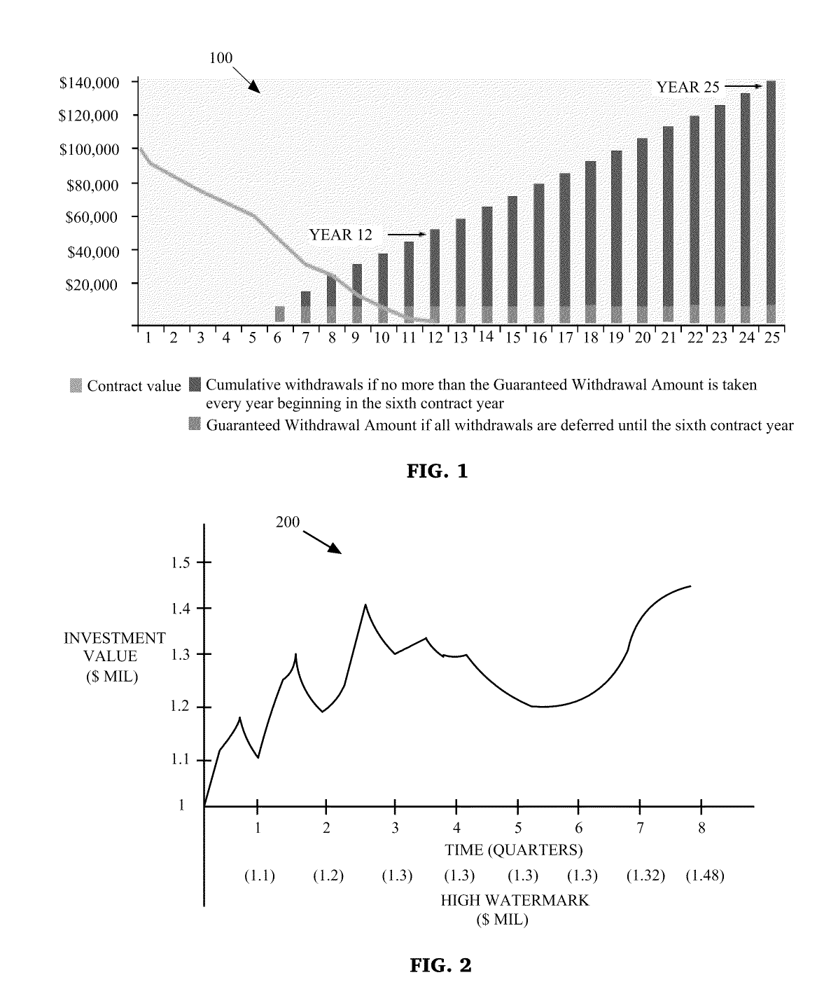

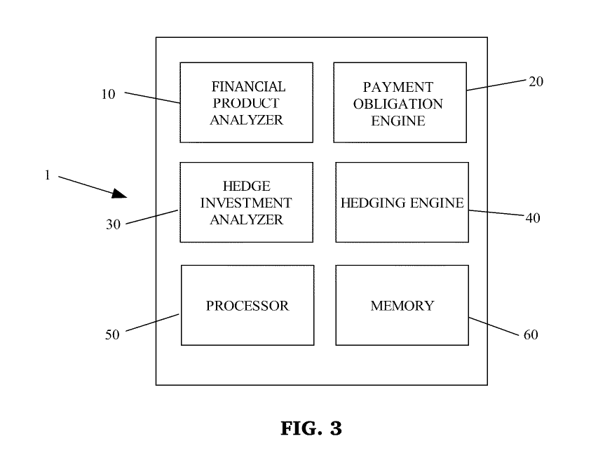

FIG. 2 shows a graph, generally designated by reference number 200, which illustrates a high watermark valuation procedure used with a financial product according to another exemplary embodiment of the present invention. In this embodiment, there is no trigger mechanism. Periodic payments are made available on a recurring basis (in this example, on a yearly basis), with watermark valuation dates being set at quarterly dates. Thus, for example, at the fourth quarter of the first year, the high watermark is $1.3 million, since that is the highest value of the watermark as measured at the quarterly observation dates. Note that in this example, even though the watermark reached a higher level between quarters 2 and 3, this higher watermark level is ignored since it was not observed on one of the quarterly observation dates. Further, the valuation of the high watermark at the observation dates may take into account withdrawals made by the policyholder. In that case, the high watermark may be the actual high value of the underlying asset. Alternatively, the previous amounts withdrawn may be ignored in determining the value of the high watermark, in which case the high watermark is based on the hypothetical situation in which no withdrawals are made to reduce the value of the underlying asset.

In an exemplary embodiment of the present invention, the risk associated with the GMWB may be hedged by investing funds in one or more assets according to a second algorithm. The one or more assets may be, for example, exchange traded or over-the-counter financial products, stocks, funds, fixed income securities, futures contracts on equities, future contracts on fixed income securities, forward contracts on equities, forward contracts on fixed income securities, option contracts on equities, option contracts on fixed income securities, and other financial products.

Preferably, the second algorithm is a function of the algorithm used to model the benchmark tied to the investment value of the underlying asset. Further, the output of the second algorithm preferably includes the expected value of the payout and the probability of paying the expected value. Thus, for example, the insurer can use this information to determine the amount of funds to invest and the appropriate combination and types of investments to select so as to balance the risk associated with the GMWB. The second algorithm may be based on any suitable simulation techniques, such as, for example, Monte Carlo simulation, Finite Difference Method, Binomial/Trinomial Tree, Black-Scholes Model, Barone Adesi and Whaley Approximation, Variance Gamma Process, Heath-Jarrow-Morton Framework, Heston Model or some other numerical method.

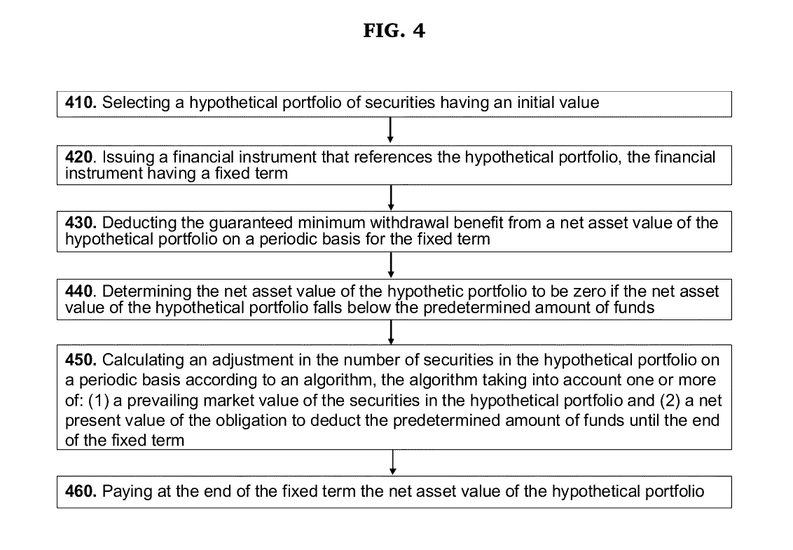

In an exemplary embodiment of the present invention, a financial institution, such as, for example, a bank, may issue one or more financial instruments for hedging an obligation to pay a GMWB or other fixed or variable payment obligations. Such financial instruments may be offered either alone and/or in conjunction with one or more annuity instruments or instruments related to annuities which specify a GMWB for payout over a fixed or variable time period. For example, the annuity instrument may be a fixed or variable annuity contract such as issued by an insurance company, however the annuity instrument may also be a financial instrument that pays a fixed amount at set intervals over a specified period of time (e.g., $10 million paid annually for ten years). With respect to the financial instruments for hedging the obligation, the financial institution may select a hypothetical portfolio of securities having an initial value, and issue a financial instrument that references the hypothetical portfolio. The hypothetical portfolio may be based on at least one index, such as the S&P 500 Index, the Dow Jones Industrial Average, the NASDAQ Composite Index, the NASDAQ-100 Index, the Russell 1000 Index, the Russell 2000 Index, the Russell 3000 Index, the Wilshire 5000 Index, the Barclays Capital U.S. Aggregate Index, and exchange traded funds tracking any of these or similar indices, for example. The hypothetical portfolio may be based on other benchmarks, or combinations of benchmarks consistent with the letter and spirit of the present invention. The financial instrument may have a fixed or variable term. The GMWB may be deducted from a net asset value of the hypothetical portfolio on a periodic basis, such as an hourly basis, daily basis, a monthly basis, quarterly basis, yearly basis, or other fixed or variable basis for the fixed or variable term. In embodiments of the present invention, the GMWB may be deducted from the net asset value of the hypothetical portfolio on an as needed basis, such as when an investor has elected to redeem the GMWB. One or more computer systems, such as described with respect to FIG. 3, may be used to calculate and publish the net asset value. The hypothetical portfolio may be further defined such that the net asset value of the hypothetical portfolio is determined to be zero if the net asset value of the hypothetical portfolio falls below a predetermined amount of funds. For example, the predetermined amount of funds may correspond to the amount of the GMWB, but may also correspond to another predetermined benchmark. An adjustment in the number of securities in the hypothetical portfolio may be calculated using one more computer systems, such as disclosed with reference to FIG. 3, on a periodic basis according to an algorithm, where the algorithm may take into account at least one of a prevailing market value of the securities in the hypothetical portfolio and a net present value of the obligation to deduct the predetermined amount of funds until the end of the fixed term. For example, the obligation to deduct the predetermined amount funds may correspond to the obligation to pay out the GMWB. An example of such an algorithm is shown below with reference to Example 1, however, other appropriate algorithms may be used consistent with the letter and spirit of the present invention. At the end of the fixed term, the financial institution may pay the net asset value of the hypothetical portfolio.

The procedure of implementing such an invention is illustrated in FIG. 4. In particular, FIG. 4 illustrates the flow chart for the method of generating one or more financial instruments for hedging an obligation to pay a GMWB according to an exemplary embodiment of the present invention. In step, 410, a hypothetical portfolio of securities having an initial value is selected. In Step 420, financial instrument that references the hypothetical portfolio is selected. The financial instrument in one embodiment has a fixed term. In Step 430, one or more computer system calculates the net asset value by deducting the GMWB from a net asset value of the hypothetical portfolio on a periodic basis for the fixed term. In Step 440, the one or more computer systems determine the net asset value of the hypothetical portfolio to be zero if the net asset value of the hypothetical portfolio falls below a predetermined amount of funds. In Step 450, the one or more computer systems calculate an adjustment in the number of securities in the hypothetical portfolio on a periodic basis according to an algorithm. The algorithm used in Step 450 may take into account at least one of a prevailing market value of the securities in the hypothetical portfolio and a net present value of the obligation to deduct the predetermined amount of funds until the end of the fixed term. In Step 460, the issuer may pay at the end of the fixed term the net asset value of the hypothetical portfolio.

In these embodiments, the investors in the financial instrument being used to hedge the obligation to pay the GMWB are exposed to the credit of the issuer. Moreover, in these embodiments, the number of securities in the hypothetical portfolio of the financial instrument is adjusted according to a risk management algorithm taking into account at least one of the prevailing market value of the securities and the net present value of the obligation to deduct the GMWB at specified times. Further, in embodiments with automatic redemptions, the net asset value of the hypothetical portfolio will automatically reduce each payment period by the GMWB.

In another set of embodiments of the present invention, a financial institution may hedge a GMWB or other fixed or variable payment obligations by setting up a Unit Investment Trust (UIT) or other appropriate fund, such as a closed-ended fund or mutual fund. The financial institution may act as the “sponsor” of the trust or “manager” of the fund. In these embodiments, assuming the GMWB is a fixed amount to be paid over a fixed term at set redemption dates for a total value of the benefit in the amount of the minimum withdrawal benefit times the total number of redemption dates, the UIT or fund may purchase a package of two instruments. The first financial instrument may be a fixed income portfolio that generates coupons. The coupons may be paid out of the UIT or fund to the UIT or fund investors. The second financial instrument references a hypothetical portfolio of securities (e.g. a benchmark like the S&P 500 Index, or a combination of indices, etc.) worth initially the total value of the benefit.

This hypothetical portfolio may have the following characteristics:

(1) The portfolio has a guaranteed withdrawal obligation at any time equal to some fixed or variable percentage of the of the highest net asset value reached by the hypothetical portfolio at given measuring points, referred to as a “high watermark”;
(2) If the net asset value of the hypothetical portfolio at any time is below the fixed percentage of the high water mark of the hypothetical portfolio, the net asset value is deemed from that point onwards to be the fixed percentage of the “high water mark” at that point; and
(3) The size of this hypothetical portfolio (i.e. the number of securities) is adjusted using one or more computers periodically, e.g., hourly, daily, weekly, monthly, quarterly, yearly, etc., according to a risk management algorithm taking into account at least one of the prevailing market value of the securities and the net present value of the guaranteed withdrawal obligation of the fixed percentage of the high water mark.

The financial instrument pays at maturity the net asset value, minus the payouts of the GMWBs of this hypothetical portfolio.

In some embodiments the financial instruments may be traded electronically on an exchange or other computer system using one or more computer systems. Similarly, the net asset value may be calculated using one or more computer systems and displayed for access by the issuer, investors and/or others using one or more computer systems.

The following examples show various methods of hedging payouts under the GMWB by purchasing a financial instrument from a financial institution to guarantee the withdrawals.

### Example 1

A financial institution purchases one or more financial instruments to hedge their own financial risk of guaranteeing a GMWB or of meeting other fixed or variable financial obligations. These instruments may be offered by a financial institution, such as a commercial bank. Assuming the GMWB is $10 million over a term of ten years for a total amount of $100 million, the financial institution may issue a package of two instruments (A) and (B) as follows:

(A) A ten year annuity paying $10 million each year for ten years; and
(B) A financial instrument which references a hypothetical portfolio of securities (e.g. a benchmark like the S&P 500 Index, or a combination of market indices, etc.) worth initially $100 million.

The hypothetical portfolio may have the following characteristics:

(1) $10 million is withdrawn and deducted from the net asset value (NAV) of the hypothetical portfolio at the end of each year for the next ten years;
(2) If the NAV of the hypothetical portfolio at any time is below $10 million, then the NAV of the hypothetical portfolio is immediately deemed to be zero from that point onwards; and
(3) The size of this hypothetical portfolio (i.e. the number of securities) is adjusted daily according to a risk management algorithm taking into account at least one of the prevailing market value of the securities and the net present value of the obligation to deduct $10 million at the end of each remaining year.

The algorithm is based on the following formula:

$$net asset value ( NAV ) = ( market value ( MV ) ) ( Number ( N ) of Security ( 1 ) ) + MV ( 2 ) ( N ( 2 ) ) + … ( MV ( N ) ) ( N ( n ) ) , \\ where \\ ( MV ( 1 ) ) ( N ( 1 ) ) / NAV = Constant ( 1 )$$

$$( MV ( 2 ) ) ( N ( 2 ) ) / NAV = Constant ( 2 )$$

$$⋮ \\ ( MV ( n ) ) ( N ( n ) ) / NAV = Constant ( n ) , \\ and$$

$$N ( 1 ) = F 1 \{ NAV , MV ( 1 ) , PV ( outstanding withdrawal obligation ) \}$$

$$N ( 2 ) = F 2 \{ NAV , MV ( 2 ) , PV ( outstanding withdrawal obligation ) \}$$

$$⋮$$

$$N ( n ) = Fn \{ NAV , MV ( n ) , PV ( outstanding withdrawal obligation ) \}$$

The financial instrument pays at the ten year maturity the NAV of this hypothetical portfolio.

### Example 2

A financial institution hedges the GMWB or other fixed or variable financial obligations by setting up a Unit Investment Trust (UIT), and acting as the “sponsor” of the trust. Assuming the GMWB is $10 million over a term of ten years for a total amount of $100 million, the UIT may purchase a package of two instruments (A) and (B) as follows:

(A) A fixed income portfolio approximately worth $80 million that generates coupons. The coupons may be paid out of the UIT to the UIT investors; and
(B) A financial instrument which references a hypothetical portfolio of securities (e.g. a benchmark like the S&P 500 Index, or a combination of indices, etc.) worth initially $100 million.

This hypothetical portfolio has the following characteristics:

(1) The portfolio has a guaranteed withdrawal obligation at any time equal to 80% of the highest NAV (i.e. 80% of the “high water mark”) reached by the hypothetical portfolio;
(2) If the NAV of the hypothetical portfolio at any time is below 80% of the highest NAV (i.e. 80% of the “high water mark”) of the hypothetical portfolio, the NAV is deemed from that point onwards to be 80% of the “high water mark” at that point; and
(3) The size of this hypothetical portfolio (i.e. the number of securities) is adjusted daily according to a risk management algorithm taking into account at least one of the prevailing market value of the securities and the net present value of the guaranteed withdrawal obligation of 80% of the high water mark.

The financial instrument pays at the ten year maturity the (NAV-$80 million) of this hypothetical portfolio.

FIG. 3 is a block diagram of a system, generally designated by reference number 1, of a system for generating a hedged financial product having a GMWB according to an exemplary embodiment of the present invention. The system 1 includes an financial product analyzer 10, a payment obligation engine 20, a hedge investment analyzer 30, a hedging engine 40, a processor 50 and a memory element 60. The various components of the system 1 may be software components that generate instructions executed by the processor 50, hardware components, or a combination of hardware and software components.

The financial product analyzer 10 tracks the performance of the investment value of the underlying asset and the associated high watermark. The payment obligation engine 20 determines the GMWB as defined by a payout calculated based on a function of an investment value of an underlying asset, for example, as a percentage of the high watermark as tracked by the financial product analyzer 10. The payment obligation engine 20 may be triggered when the investment value of the underlying asset reaches a predetermined percentage of the high watermark.

The hedge investment analyzer 30 determines one or more assets in which to invest so as to hedge the GMWB. In this regard, the hedge investment analyzer 30 solves the second algorithm, which is a function of the algorithm used to model the investment value of the underlying asset. Thus, the hedge investment analyzer 30 preferably uses the expected value of the periodic payments and the probability of paying the expected value as an output of the second algorithm to determine the appropriate amounts of invested funds and types of investments.

The hedging engine 40 uses the investment information provided by the hedge investment analyzer 30 to invest funds in the appropriate investment products. In this regard, the hedging engine may track the performance of the investments to determine whether adjustments to the second algorithm need to be made in order to properly hedge the GMWB. Thus, the hedging engine 40 may provide feedback data to the hedge investment analyzer 30 that results in suitable adjustments to the hedge investments.

While this invention has been described in conjunction with the exemplary embodiments outlined above, it is evident that many alternatives, modifications and variations will be apparent to those skilled in the art. Accordingly, the exemplary embodiments of the invention, as set forth above, are intended to be illustrative, not limiting. Various changes may be made without departing from the spirit and scope of the invention.

What is claimed is:

1. A method comprising the steps of:
selecting a hypothetical portfolio of securities having an initial value;
issuing a financial instrument that references the hypothetical portfolio, the financial instrument having a fixed term;
deducting a guaranteed minimum withdrawal benefit from a net asset value of the hypothetical portfolio on a periodic basis for the fixed term;
determining the net asset value of the hypothetical portfolio to be zero if the net asset value of the hypothetical portfolio falls below a predetermined amount of funds;
calculating with a computer an adjustment in a number of securities in the hypothetical portfolio on a periodic basis according to an algorithm, the algorithm taking into account at least one of a prevailing market value of the securities in the hypothetical portfolio and a net present value of an obligation to deduct the predetermined amount of funds until the end of the fixed term; and
paying at the end of the fixed term the net asset value of the hypothetical portfolio.

2. The method of claim 1, further comprising the step of issuing a second financial instrument, the second financial instrument being an annuity that pays the guaranteed minimum withdrawal benefit on the periodic basis for the fixed term.

3. The method of claim 1, wherein the algorithm is based on the following formula:
$$net asset value ( NAV ) = ( market value ( MV ) ) ( Number ( N ) of Security ( 1 ) ) + MV ( 2 ) ( N ( 2 ) ) + … ( MV ( N ) ) ( N ( n ) ) , \\ where \\ ( MV ( 1 ) ) ( N ( 1 ) ) / NAV = Constant ( 1 )$$
$$( MV ( 2 ) ) ( N ( 2 ) ) / NAV = Constant ( 2 )$$
$$⋮ \\ ( MV ( n ) ) ( N ( n ) ) / NAV = Constant ( n ) , \\ and$$
$$N ( 1 ) = F 1 \{ NAV , MV ( 1 ) , PV ( outstanding withdrawal obligation ) \}$$
$$N ( 2 ) = F 2 \{ NAV , MV ( 2 ) , PV ( outstanding withdrawal obligation ) \}$$
$$⋮$$
$$N ( n ) = Fn \{ NAV , MV ( n ) , PV ( outstanding withdrawal obligation ) \} .$$

4. The method of claim 1, wherein the hypothetical portfolio is based on at least one of the S&P 500 Index, the Dow Jones Industrial Average, the NASDAQ Composite Index, the NASDAQ-100 Index, the Russell 1000 Index, the Russell 2000 Index, the Russell 3000 Index, the Wilshire 5000 Index, the Barclays Capital U.S. Aggregate Index, and exchange traded funds tracking any of these indices.

5. A computer-based system comprising one or more computer readable media containing computer readable instructions executable on one or more computer processors to perform a method comprising the steps of:
processing data concerning a hypothetical portfolio of securities having an initial value;
processing data concerning a financial instrument that references the hypothetical portfolio, the financial instrument having a fixed term;
deducting a guaranteed minimum withdrawal benefit from a net asset value of the hypothetical portfolio on a periodic basis for the fixed term;
determining the net asset value of the hypothetical portfolio to be zero if the net asset value of the hypothetical portfolio falls below a predetermined amount of funds;
calculating an adjustment in a number of securities in the hypothetical portfolio on a periodic basis according to an algorithm, the algorithm taking into account at least one of a prevailing market value of the securities in the hypothetical portfolio and a net present value of an obligation to deduct the predetermined amount of funds until the end of the fixed term; and
paying at the end of the fixed term the net asset value of the hypothetical portfolio.

6. The computer-based system of claim 5, further comprising the step of issuing a second financial instrument, the second financial instrument being an annuity that pays the guaranteed minimum withdrawal benefit on the periodic basis for the fixed term.

7. The computer-based system of claim 5, wherein the algorithm is based on the following formula:
$$net asset value ( NAV ) = ( market value ( MV ) ) ( Number ( N ) of Security ( 1 ) ) + MV ( 2 ) ( N ( 2 ) ) + … ( MV ( N ) ) ( N ( n ) ) , \\ where \\ ( MV ( 1 ) ) ( N ( 1 ) ) / NAV = Constant ( 1 )$$
$$( MV ( 2 ) ) ( N ( 2 ) ) / NAV = Constant ( 2 )$$
$$⋮ \\ ( MV ( n ) ) ( N ( n ) ) / NAV = Constant ( n ) , \\ and$$
$$N ( 1 ) = F 1 \{ NAV , MV ( 1 ) , PV ( outstanding withdrawal obligation ) \}$$
$$N ( 2 ) = F 2 \{ NAV , MV ( 2 ) , PV ( outstanding withdrawal obligation ) \}$$
$$⋮$$
$$N ( n ) = Fn \{ NAV , MV ( n ) , PV ( outstanding withdrawal obligation ) \} .$$

8. The computer-based system of claim 5, wherein the hypothetical portfolio is based on at least one of the S&P 500 Index, the Dow Jones Industrial Average, the NASDAQ Composite Index, the NASDAQ-100 Index, the Russell 1000 Index, the Russell 2000 Index, the Russell 3000 Index, the Wilshire 5000 Index, the Barclays Capital U.S. Aggregate Index, and exchange traded funds tracking any of these indices.

9. A method comprising the steps of:
selecting a hypothetical portfolio of securities having an initial value;
issuing a financial instrument that references the hypothetical portfolio, the financial instrument having a fixed term;
deducting a predetermined payment obligation from a net asset value of the hypothetical portfolio on a periodic basis for the fixed term;
determining the net asset value of the hypothetical portfolio to be zero if the net asset value of the hypothetical portfolio falls below a predetermined amount of funds;
calculating with a computer an adjustment in a number of securities in the hypothetical portfolio on a periodic basis according to an algorithm, the algorithm taking into account at least one of a prevailing market value of the securities in the hypothetical portfolio and a net present value of an obligation to deduct the predetermined amount of funds until the end of the fixed term; and
paying at the end of the fixed term the net asset value of the hypothetical portfolio.

10. The method of claim 9, further comprising the step of issuing a second financial instrument, the second financial instrument being an annuity that pays the predetermined payment obligation on the periodic basis for the fixed term.

11. The method of claim 9, wherein the algorithm is based on the following formula:
$$net asset value ( NAV ) = ( market value ( MV ) ) ( Number ( N ) of Security ( 1 ) ) + MV ( 2 ) ( N ( 2 ) ) + … ( MV ( N ) ) ( N ( n ) ) , \\ where \\ ( MV ( 1 ) ) ( N ( 1 ) ) / NAV = Constant ( 1 )$$
$$( MV ( 2 ) ) ( N ( 2 ) ) / NAV = Constant ( 2 )$$
$$⋮ \\ ( MV ( n ) ) ( N ( n ) ) / NAV = Constant ( n ) , \\ and$$
$$N ( 1 ) = F 1 \{ NAV , MV ( 1 ) , PV ( outstanding withdrawal obligation ) \}$$
$$N ( 2 ) = F 2 \{ NAV , MV ( 2 ) , PV ( outstanding withdrawal obligation ) \}$$
$$⋮$$
$$N ( n ) = Fn \{ NAV , MV ( n ) , PV ( outstanding withdrawal obligation ) \} .$$

12. The method of claim 9, wherein the hypothetical portfolio is based on at least one of the S&P 500 Index, the Dow Jones Industrial Average, the NASDAQ Composite Index, the NASDAQ-100 Index, the Russell 1000 Index, the Russell 2000 Index, the Russell 3000 Index, the Wilshire 5000 Index, the Barclays Capital U.S. Aggregate Index, and exchange traded funds tracking any of these indices.

13. The method of claim 9, wherein the predetermined payment obligation is one of a fixed or variable payment obligation.

14. The method of claim 13, wherein the predetermined payment obligation is a guaranteed minimum withdrawal benefit.

15. A computer-based system comprising one or more computer readable media containing computer readable instructions executable on one or more computer processors to perform a method comprising the steps of:
processing data concerning a hypothetical portfolio of securities having an initial value;
processing data concerning a financial instrument that references the hypothetical portfolio, the financial instrument having a fixed term;
deducting a predetermined payment obligation from a net asset value of the hypothetical portfolio on a periodic basis for the fixed term;
determining the net asset value of the hypothetical portfolio to be zero if the net asset value of the hypothetical portfolio falls below a predetermined amount of funds;
calculating an adjustment in a number of securities in the hypothetical portfolio on a periodic basis according to an algorithm, the algorithm taking into account at least one of a prevailing market value of the securities in the hypothetical portfolio and a net present value of an obligation to deduct the predetermined amount of funds until the end of the fixed term; and
paying at the end of the fixed term the net asset value of the hypothetical portfolio.

16. The computer-based system of claim 15, further comprising the step of issuing a second financial instrument, the second financial instrument being an annuity that pays a predetermined payment obligation on the periodic basis for the fixed term.

17. The computer-based system of claim 15, wherein the algorithm is based on the following formula:
$$net asset value ( NAV ) = ( market value ( MV ) ) ( Number ( N ) of Security ( 1 ) ) + MV ( 2 ) ( N ( 2 ) ) + … ( MV ( N ) ) ( N ( n ) ) , \\ where \\ ( MV ( 1 ) ) ( N ( 1 ) ) / NAV = Constant ( 1 )$$
$$( MV ( 2 ) ) ( N ( 2 ) ) / NAV = Constant ( 2 )$$
$$⋮ \\ ( MV ( n ) ) ( N ( n ) ) / NAV = Constant ( n ) , \\ and$$
$$N ( 1 ) = F 1 \{ NAV , MV ( 1 ) , PV ( outstanding withdrawal obligation ) \}$$
$$N ( 2 ) = F 2 \{ NAV , MV ( 2 ) , PV ( outstanding withdrawal obligation ) \}$$
$$⋮$$
$$N ( n ) = Fn \{ NAV , MV ( n ) , PV ( outstanding withdrawal obligation ) \} .$$

18. The computer-based system of claim 15, wherein the hypothetical portfolio is based on at least one of the S&P 500 Index, the Dow Jones Industrial Average, the NASDAQ Composite Index, the NASDAQ-100 Index, the Russell 1000 Index, the Russell 2000 Index, the Russell 3000 Index, the Wilshire 5000 Index, the Barclays Capital U.S. Aggregate Index, and exchange traded funds tracking any of these indices.

19. The computer-based system of claim 15, wherein the predetermined payment obligation is one of a fixed or variable payment obligation.

20. The computer-based system of claim 19, wherein the predetermined payment obligation is a guaranteed minimum withdrawal benefit.
